(19) United States
(12) Patent Application Publication
(10) Pub. No.: US 2016/0191697 A1
(43) Pub. Date: Jun. 30, 2016

(54) MOBILE TERMINAL AND METHOD FOR SWITCHING UNLOCKING MODES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YANG-YANG CHEN, Shenzhen (CN); CHIH-HUA HSU, New Taipei (TW)

(21) Appl. No.: 14/713,708

(22) Filed: May 15, 2015

(30) Foreign Application Priority Data
Dec. 29, 2014 (CN) 201410841511.6

(51) Int. Cl. H04M 1/725; H04W 4/02

(52) U.S. Cl. CPC H04M 1/72577; H04W 4/02

(57) ABSTRACT

A method for switching unlocking modes of a mobile terminal includes controlling a locating device of the mobile terminal to determine a current position of the mobile terminal, and determining a location ranges that the current position falls into. According to the determined location ranges and a pre-stored relation list which defines a relationship between multiple location ranges and multiple unlocking modes for the mobile terminal, a new unlocking mode corresponding to the determined location range is determined. A current unlocking mode of the mobile terminal is switched to the new unlocking mode.

### CROSS-REFERENCE TO RELATED APPLICATIONS

This application claims priority to Chinese Patent Application No. 201410841511.6 filed on Dec. 29, 2014, the contents of which are incorporated by reference herein.

### FIELD

The subject matter herein generally relates to a mobile terminal and a method for switching unlocking modes.

### BACKGROUND

Screen locks are set intricately to protect privacy information in mobile phones. However, when a user is in some private places, such as at home, it is unnecessary to set an intricate screen lock.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a mobile terminal including a system for switching unlocking modes.

FIG. 2 illustrates a flowchart of one embodiment of a method for switching unlocking modes of the mobile terminal of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in details so as not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media includes CDs, DVDs, BLU-RAY, flash memory, and hard disk drives. The term “comprising” means “including, but not necessarily limited to”; it specifically indicates open-ended inclusion or membership in a so-described combination, group, series and the like.

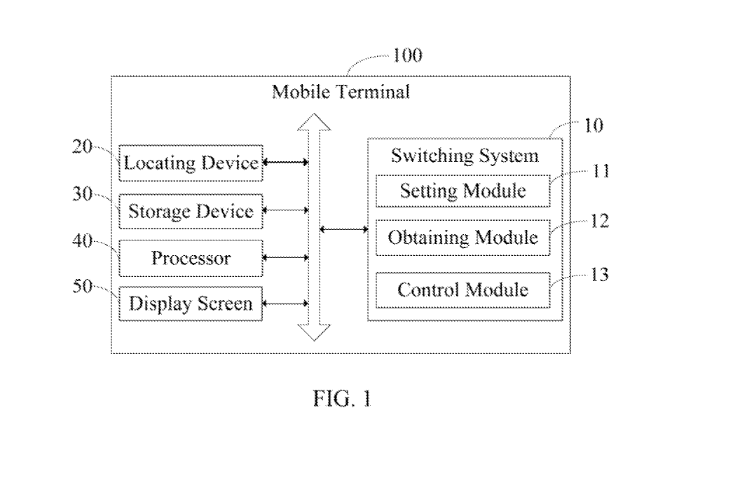

FIG. 1 illustrates a block diagram of one embodiment of a mobile terminal. In at least one the embodiment as shown in FIG. 1, a mobile terminal 100 includes, but is not limited to, a switching system 10, a locating device 20, a storage device 30, at least one processor 40 and a display screen 50. The mobile terminal 100 can be a tablet computer, a notebook computer, a smart phone, a personal digital assistant (PDA), or another suitable electronic device. FIG. 1 illustrates only one example of the mobile terminal 100 that can include more or fewer components than illustrated, or have a different configuration of the various components in other embodiments.

The switching system 10 can switch unlocking modes for the mobile terminal 100 according to the current position of the mobile terminal 100.

The locating device 20 can determine a current position of the mobile terminal 100. The display screen 50 can display a user interface, such as unlocking the interface and the like.

In at least one embodiment, the storage device 30 can include various types of non-transitory computer-readable storage mediums. For example, the storage device 30 can be an internal storage system, such as a flash memory, a random access memory (RAM) for temporary storage of information, and/or a read-only memory (ROM) for permanent storage of information. The storage device 30 can also be an external system, such as a hard disk, a storage card, or a data storage medium. The at least one processor 40 can be a central processing unit (CPU), a microprocessor, or other data processor chip that performs functions of the switching system 10 in the mobile terminal 100.

In at least one embodiment, the switching system 10 can include a setting module 11, an obtaining module 12 and a control module 13. The function modules 11-13 can include computerized codes in the form of one or more programs, which are stored in the storage device 30. The at least one processor 40 executes the computerized codes to provide functions of the function modules 11-13.

The setting module 11 provides a user interface for a user to preset multiple location ranges, multiple unlocking modes and a relation list which defines a relationship between the multiple location ranges and the multiple unlocking modes to be stored in the storage device 30. The multiple location ranges can be the places where the user often goes, such as home, company, or some public places where the user often goes. The multiple unlocking modes can be different unlocking ways, such as gesture password, digital password, fingerprint recognition, facial recognition and the like. The multiple unlocking modes can also be the same unlocking way having different passwords, such as gesture A and gesture B. In some embodiments, the multiple unlocking modes can include a mode of no screen lock. In the embodiment, the multiple location ranges include a first location range and a second location range. The multiple unlocking modes include a first unlocking mode, a second unlocking mode and a third unlocking mode.

The control module 13 controls the locating device 20 to determine a current position of the mobile terminal 100.

The obtaining module 12 obtains the current position determined by the locating device 20 and determines a location range that the obtained current position falls into. The obtaining module 12 further queries the relation list at the determined location range to determine a new unlocking mode. In at least one embodiment, if the obtained current position falls into the first location range, such as home, the obtaining module 12 determines the first unlocking mode, such as a mode of no screen lock or a mode of simple gesture password, as the new unlocking mode. If the obtained current position falls into the second location range, such as company, the obtaining module 12 determines the second unlocking mode, such as mode of complex gesture password, as the new unlocking mode. If the obtained current position falls into neither the first location range nor the second location range, such as shopping mall or other public places, the obtaining module 12 determines the third unlocking mode, such as fingerprint recognition or other physiological feature recognition, as the new unlocking mode.

The control module 13 switches a current unlocking mode of the mobile terminal 100 to the new unlocking mode.

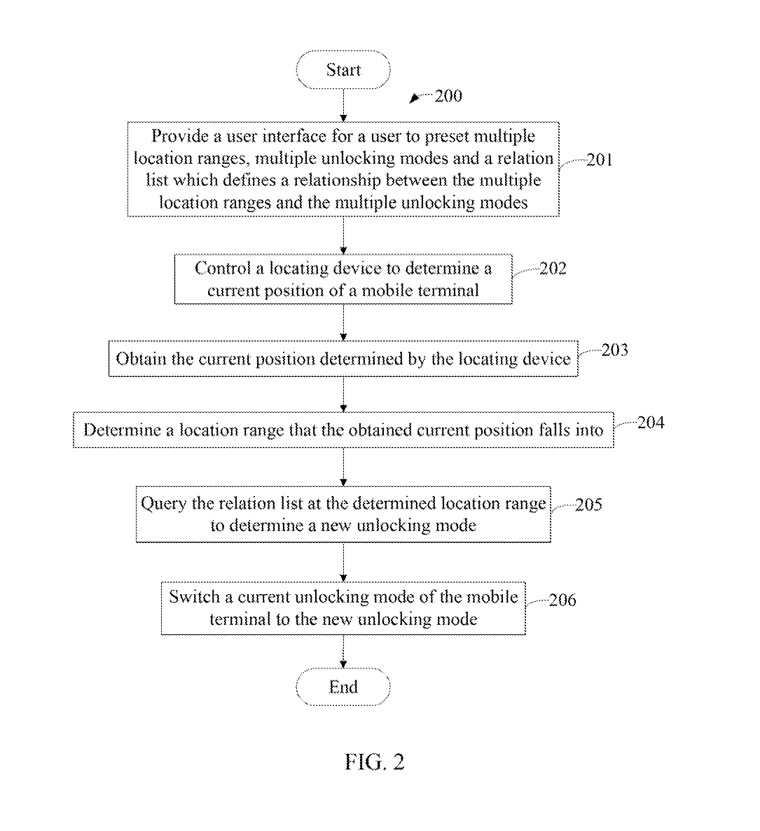

Referring to FIG. 2, a flowchart of a method for switching unlocking modes is presented in accordance with an example embodiment. The example method 200 is provided by way of example, as there are a variety of ways to carry out the method. The example method 200 described below can be carried out using the configurations illustrated in FIG. 1 for example, and various elements of these figures are referenced in explaining example method 200. Each block shown in FIG. 2 represents one or more processes, methods, or subroutines carried out in the example method 200. Furthermore, the illustrated order of blocks is by example only and the order of the blocks can be changed. The example method 200 can begin at block 201. Depending on the embodiment, additional steps can be added, others removed, and the ordering of the steps can be changed.

At block 201, a setting module provides a user interface for a user to preset multiple location ranges, multiple unlocking modes and a relation list which defines a relationship between the multiple location ranges and the multiple unlocking modes to be stored in a storage device 30.

At block 202, a control module controls a locating device 20 to determine a current position of a mobile terminal 100.

At block 203, an obtaining module obtains the current position determined by the locating device 20.

At block 204, the obtaining module determines a location range that the obtained current position falls into.

At block 205, the obtaining module queries the relation list at the determined location range to determine a new unlocking mode. In the embodiment, the obtaining module determines a first unlocking mode as the new unlocking mode if the obtained current position falls into a first location range; a second unlocking mode is determined as the new unlocking mode if the obtained current position falls into a second location range; and a third unlocking mode is determined as the new unlocking mode if the obtained current position falls into neither the first location range nor the second location range.

At block 206, the control module switches a current unlocking mode of the mobile terminal 100 to the new unlocking mode.

With such a configuration, the unlocking mode can be switched with the current position of the mobile terminal 100 changes.

It should be emphasized that above-described embodiment of the present disclosure including any particular embodiments, are merely examples of implementations set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A mobile terminal comprising:
a locating device;
at least one processor coupled to the locating device; and
a non-transitory storage device that stores a relation list defining a relationship between multiple location ranges and multiple unlocking modes for the mobile terminal, the storage device further stores one or more programs which, when executed by the at least one processor, cause the at least one processor to:
control the locating device to determine a current position of the mobile terminal;
obtain the current position determined by the locating device;
determine a location range that the obtained current position falls into;
query the relation list at the determined location range to determine a new unlocking mode; and
switch a current unlocking mode of the mobile terminal to the new unlocking mode.

2. The mobile terminal according to claim 1, wherein the at least one processor provides a user interface for a user to preset the multiple location ranges, the multiple unlocking modes and the relation list which defines the relationship between the multiple location ranges and the multiple unlocking modes.

3. The mobile terminal according to claim 1, wherein the at least one processor determines a first unlocking mode as the new unlocking mode if the obtained current position falls into a first location range, determines a second unlocking mode as the new unlocking mode if the obtained current position falls into a second location range, and determines a third unlocking mode as the new unlocking mode if the obtained current position falls into neither the first location range nor the second location range.

4. A computer-implemented method for switching unlocking modes of a mobile terminal being executed by a processor of the mobile terminal, the method comprising:
controlling a locating device of the mobile terminal to determine a current position of the mobile terminal;
obtaining the current position determined by the locating device;
determining a location range that the obtained current position falls into;
querying a relation list stored in a storage device of the mobile terminal at the determined location range to determine a new unlocking mode; wherein the relation list defines a relationship between multiple location ranges and multiple unlocking modes for the mobile terminal; and
switching a current unlocking mode of the mobile terminal to the new unlocking mode.

5. The method according to claim 4, further comprising:
providing a user interface for a user to preset the multiple location ranges, the multiple unlocking modes and the relation list which defines the relationship between the multiple location ranges and the multiple unlocking modes.

6. The method according to claim 4, wherein querying a relation list at the determined location range to determine a new unlocking mode comprising:
determining that the obtained current position falls into a first location range;
upon such determination, determining a first unlocking mode as the new unlocking mode;
determining that the obtained current position falls into a second location range;
upon such determination, determining a second unlocking mode as the new unlocking mode;
determining that the obtained current position falls into neither the first location range nor the second location range; and
upon such determination, determining a third unlocking mode as the new unlocking mode.

7. A non-transitory storage medium having stored thereon instructions that, when executed by a processor of a mobile terminal, causes the processor to perform a method for switching unlocking modes of the mobile terminal, the method comprising:
controlling a locating device of the mobile terminal to determine a current position of the mobile terminal;
obtaining the current position determined by the locating device;
determining a location range that the obtained current position falls into;
querying a relation list stored in a storage device of the mobile terminal at the determined location range to determine a new unlocking mode; wherein the relation list defines a relationship between multiple location ranges and multiple unlocking modes for the mobile terminal; and
switching a current unlocking mode of the mobile terminal to the new unlocking mode.

8. The non-transitory storage medium according to claim 7, wherein the method further comprising:
providing a user interface for a user to preset the multiple location ranges, the multiple unlocking modes and the relation list which defines the relationship between the multiple location ranges and the multiple unlocking modes.

9. The non-transitory storage medium according to claim 7, wherein querying a relation list at the determined location range to determine a new unlocking mode comprising:
determining that the obtained current position falls into a first location range;
upon such determination, determining a first unlocking mode as the new unlocking mode;
determining that the obtained current position falls into a second location range;
upon such determination, determining a second unlocking mode as the new unlocking mode;
determining that the obtained current position falls into neither the first location range nor the second location range; and
upon such determination, determining a third unlocking mode as the new unlocking mode.
